(19) United States
(12) Patent Application Publication
(10) Pub. No.: US 2022/0143563 A1
(43) Pub. Date: May 12, 2022

(54) NON-INVASIVE MIXING OF LIQUIDS

(71) Applicant: Nederlandse Organisatie voor toegepast-natuurwetenschappelijk onderzoek TNO, 's-Gravenhage (NL)

(72) Inventors: Paul Louis Maria Joseph VAN NEER, Bergschenhoek (NL); Rajat BHARDWAJ, Delft (NL); Gert-Jan Adriaan VAN GROENESTIJN, Rijswijk (NL); Earl Lawrence Vincent GOETHEER, Mol (BE); Cornelis Petrus Marcus ROELANDS, Voorschoten (NL)

(21) Appl. No.: 17/437,745

(22) PCT Filed: Mar. 12, 2020
(86) PCT No.: PCT/NL2020/050164

§ 371 Date: Sep. 9, 2021

(30) Foreign Application Priority Data
Mar. 14, 2019 (EP) 19162758.7

(51) Int. Cl. B01F 31/86; B01F 31/80; B01F 35/213; B01F 35/22; B01F 35/221

(52) U.S. Cl. CPC B01F 31/86; B01F 31/89; B01F 2101/07; B01F 35/2209; B01F 35/2214; B01F 35/213

(57) ABSTRACT

An apparatus (100) for mixing a fluid (F) comprises a mixing container (10) with a container wall (11) for holding the fluid (F). One or more acoustic transducers (21, 22) are arranged on the container wall (11) and configured to generate respective acoustic waves (W1, W2) directed into the fluid (F) for causing a respective flow pattern (F1, F2) in the fluid (F) by acoustic streaming. A controller (15) is configured to control the acoustic transducers (21, 22) to automatically switch between generation of different acoustic waves (W1, W2) for causing switching between different flow patterns (F1, F2).

### TECHNICAL FIELD AND BACKGROUND

The present disclosure relates to mixing of fluids, e.g. liquids such as milk.

In a large number of industries, e.g., food, chemical and pharmaceutical industries, dispersions, suspensions and emulsions need to be mixed or kept mixed. Often there is a strong driver for hygiene or sterility to maximize product shelf life. In such industries, traditional mixing involves the insertion of a component (e.g. impeller) into the dispersion, suspension, or emulsion to facilitate the mixing. However, this component may require cleaning which may cost time, Additionally, cleaning may involve labor and energy costs each time cleaning is performed. So cleaning is an important part of the costs in for example the food industry such as dairy products.

Ultrasonic cleaning baths use ultrasound to clean/mix/increase chemical reactions. However, these are typically based on high power ultrasound with high intensities only located at a small defined spot where the operating principle is dominated by cavitation and locally induced temperature increases. Applications of ultrasonic mixing/sorting may also occur in microfluidic setups. Typically, standing waves are used which are relatively easy to realize in microfluidic setups but infeasible for larger setups. Unfortunately, the known ultrasound based mixing may be unsuitable for use with easily damaged liquids, e.g. dispersions and emulsions. For many liquids there is an upper allowable limit for the peak liquid velocities or the induced shear stresses. For example, for milk an upper limit can be determined by the breaking up of protein-fat structure at high shear stress. But staying below the upper limit may result in insufficient mixing.

Thus, there is a need for further improvements in the mixing of fluids Which may alleviate disadvantages of the known methods while maintaining at least some of their advantages.

### SUMMARY

Aspects of the present disclosure relate to an apparatus and method for mixing a fluid, e.g. liquid. A mixing container with a container wall can be used for holding the fluid. One or more acoustic transducers can be arranged on the container wall. The acoustic transducers may be configured to generate respective acoustic waves directed into the fluid. This may cause a respective flow pattern in the fluid (acoustic streaming). For example, a flow pattern can be described by the respective flow directions and/or flow velocities of the fluid at one or more positions in the mixing container. Typically, mixing is achieved by a flow carrying the fluid and/or particles therein throughout the container.

Preferably, the one or more acoustic transducers are controlled to automatically switch between the generation of different acoustic waves. This may cause switching between different flow patterns to improve the fluid mixing without having to increase actuation power. The inventors recognize that, without switching the acoustic wave generation, a fixed or steady state flow pattern may develop, e.g. wherein the flow direction and velocity at positions in the fluid no longer changes. For example, in a fixed flow pattern, laminar flows may develop in which minimal mixing takes place. Also a fixed flow pattern may, include regions where the fluid remains stagnant. Different flow patterns may be formed, e.g., by switching the flow direction and/or flow velocity at one or more positions, preferably throughout the container. Advantageously, switching between different flows may disrupt laminar flows and/or stagnant regions in the container, e.g. create vortices which can improve mixing performance. So, instead of, e.g., increasing power to the transducers (which may damage the fluid by excessive flow/shearing), mixing efficiency may be improved by switching different mixing modes without damaging the fluid.

### BRIEF DESCRIPTION OF DRAWINGS

These and other features, aspects, and advantages of the apparatus, systems and methods of the present disclosure will become better understood from the following description, appended claims, and accompanying drawing wherein:

FIGS. 1A and 113 illustrate circular flow patterns;

FIGS. 2A and 2B illustrate helical flow patterns;

FIGS. 3A and 3B illustrate flow patterns with opposing flow directions;

FIGS. 4A and 4B illustrate a toroidal or donut shaped mixing container;

FIGS. 5A and 5B illustrate acoustic waves directed at an angle with respect to an opposing wall;

FIGS. 6A and 6B illustrate a combination of acoustic streaming and radiation force;

FIG. 7A illustrates a pressure distribution intensity;

FIG. 7B illustrates interference between acoustic waves.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

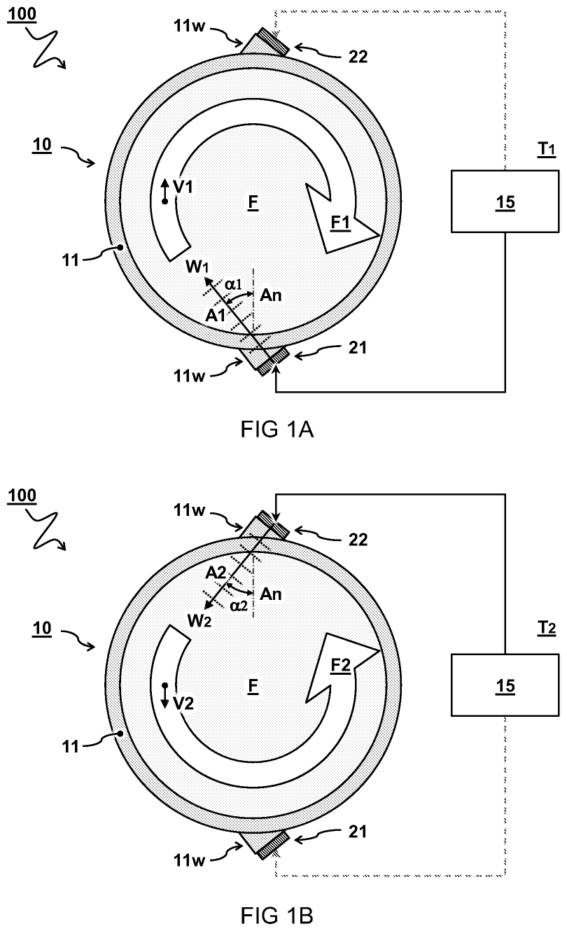

FIGS. 1A and 113 illustrate aspects described herein embodied as an apparatus 100 for mixing a fluid F. Typically, the apparatus 100 comprises a mixing container 10 with container walls 11 for holding the fluid F. As described herein, the apparatus typically has at least one transducer arranged on the container wall 11 for mixing the fluid F. In a preferred embodiment, e.g. as shown, a plurality of acoustic transducers 21,22 are arranged on the container wall 11, In another or further embodiment, the one or more acoustic transducers 21,22 are configured to generate respective acoustic waves W1,W2 directed into the fluid F for causing a respective flow pattern F1,F2 in the fluid F, preferably by acoustic streaming, Aspects described herein may also be embodied as a method for mixing the fluid F. Typically, the method comprises holding the fluid F in a mixing container 10 and generating respective acoustic waves W1,W2 directed into the fluid F for causing a respective flow pattern F1,F2 in the fluid F by acoustic streaming.

In some embodiments, a controller 15 configured to control the one or more acoustic transducers 21,22. In a preferred embodiment, the controller is configured (e.g. programmed) to automatically switch between generation of different acoustic waves W1,W2. This may cause switching between different flow patterns F1, F2 to improve the fluid mixing. Similarly, the method may also comprise switching (by a controller or otherwise) between the generation of different acoustic waves W1,W2 for causing switching between different flow patterns F1,F2. While switching between different flow patterns can provide synergetic advantages in combination with the various aspects described herein, it can also be envisaged to apply at least some of the present teachings without switching. In particular, aspects and advantages described herein such as circular/helical flow patterns, opposing/shearing flow patterns, flow patterns at an angle to an opposing wall and/or impacting acoustic waves on a liquid/gas interface, container/transducer configurations and operational parameters, can also be applied without switching to achieve at least some of the advantages of effective fluid mixing.

In some embodiments, actuation (with or without intermittent switching) is maintained for relatively long periods of time, e.g. longer than a minute, ten minutes, half an hour, or more. For example, some fluids such as milk may need constant mixing to maintain desirable properties. Accordingly, the mixing may be maintained for as long as the fluid is s red in the mixing container 10. In some embodiments, actuation may be switched off, e.g., when mixing is deemed sufficient. The actuation may also be temporarily switched off, e.g. in a cycle between different actuation modes.

In some embodiments, the acoustic transducers 21,22 are configured to cause a first flow pattern F1 by generating a first set of acoustic waves W1 over a first period of time T1 and then automatically switch to cause a different, second flow pattern F2 by generating a different, second set of acoustic waves W2 over a second period of time T2. In one embodiment, the time periods T1,T2 may be selected to correspond to a time it takes for a fixed flow pattern to develop in the container, e.g. a predominant laminar flow. By switching the transducers around this time (or before this time), the fixed flow pattern may be disrupted to maintain optimal mixing conditions. For example, each time period T1,T2 may be at least one second, two seconds, five seconds, or more than ten seconds. For example, each flow pattern may be maintained between one and hundred seconds before switching to the next flow pattern, preferably between five and thirty seconds, or between ten and twenty seconds.

In some embodiments, a first subset of transducers 21 is configured to cause the first flow pattern F1, and a different, second subset of transducers 22 is configured to cause the second flow pattern F2. In one embodiment, the respective subsets of transducers may be exclusive. For example, transducers belonging to the first subset do not belong to the second subset, and vice versa. Advantageously, each subset of transducers 21,22 may be specifically arranged to cause a particular respective flow pattern F1 F2, as shown. In other or further embodiments, one or more transducers may be shared between subsets (not shown here).For example, some transducers which belong to the first subset may also belong to the second subset, while other transducers may be exclusive to the respective subset.

In some embodiments, different flow patterns F1,F2 are generated by (the controller 15) switching actuating between different subsets of actuators 21,22. For example, to generate a first flow pattern F1 a first set of actuators 21 is actuated. For example, to generate a second flow pattern F2 a different second set of actuators 22 is actuated. In one embodiment, different flow patterns F1,F2 may be generated by switching operational parameters of one or more actuators belonging to one or more sets. For example, switching a flow pattern may be altered by switching one or more actuators from a first actuating frequency to a different, second actuating frequency.

In some embodiments, the flow pattern is abruptly changed, e.g. by switching the actuation within one second from one mode of operation to an entirely different mode. For example, a first set of one or more acoustic transducers 21 is switched off, while at the same time, or shortly after, a second set of one or more acoustic transducers 22 is switched on. The abrupt, switching may e.g. cause vortex formation by the sudden change in flow direction to improve mixing. In other or further embodiments, the flow pattern may be switched to gradually vary the flow. For example, actuation of a first set of one or more acoustic transducers 21 is ramped down, while actuation of a one or more second set of acoustic transducers 22 is ramped up, e.g. over a period of one second, or a few seconds, e.g. up to ten seconds, or more.

In some embodiments, the one or more acoustic transducers 21,22 are configured to alternate between two, three, four, five, or more different flow patterns. The higher the number of different flow patterns, the better they may complement each other in efficiently mixing the fluid. Preferably, the flow patterns are as distinct as possible, e.g. having entirely different flow directions.

In some embodiments, the first flow pattern F1 has a first flow direction V1 and the second flow pattern F2 has a different, second flow direction V2. Advantageously, switching between flow pattern F1,F2 with different flow directions V1,V2 may disrupt laminar flows and/or counteract stagnant regions in the mixing container 10. In one embodiment, the flow direction V1 is substantially opposite to the second flow direction V2. For example, an average flow direction V1 of the first flow pattern F1 at a position in the mixing container 10 may be at a relatively large angle with respect to an average flow direction V2 of the first flow pattern F1 at the same position, e.g. an angle of more than ninety degrees, more than hundred-twenty degrees, more than hundred-fifty degrees, up to hundred-eighty degrees (completely opposite). For example, the first flow pattern F1 may be clockwise and the second flow pattern may be counterclockwise. In another or further embodiment, (not shown here), the first flow direction V1 is substantially transverse to the second flow direction V2, e.g. wherein the angle between the average flow directions V1,V2 is between forty-five and hundred-thirty-five degrees.

In some embodiments, different flow directions may be achieved by having acoustic waves W1,W2 originate from different acoustic transducers 21,22 and/or using waves/transducers oriented at different angles α1,α2. Typically, the acoustic waves W1,W2 are directed along a respective acoustic axis A1,A2 into the fluid F. In one embodiment, e.g. as shown, the acoustic axis A1,A2 is at a respective angle α1,α2 with respect to a normal An of the (inner) container wall 11 for causing a main flow component of the respective fluid flow F1,F2 tangential to the container wall 11. For example, the angle α is more than ten degrees (plane angle), preferably more than twenty degrees, or even more than thirty degrees, more than forty degrees, or more than fifty degrees, e.g. between forty and eighty degrees. The higher the angle α (up to ninety degrees), the more the fluid may start a flow pattern directed along the wall.

In some embodiments, e.g. as shown, a first acoustic transducer 21 has an acoustic axis A1 at a first angle α1 with respect to a normal An of the container wall 11, and a second acoustic transducer 22 has an acoustic axis A2 at a second angle α2 with respect to a normal An of the container wall 11. In one embodiment, the angles α1,α2 may be the same but e.g. oriented in different directions. For example, the angles α1, α2 may be oppositely directed along a circumference of the container wall 11, as shown. Alternatively, or additionally, the directions of the angles α1,α2 with respect to the respective normal An may also have transversely oriented components (not visible here).

In some embodiments, the one or more acoustic transducers 21,22 are arranged on an outside of the mixing container 10, i.e. on an opposite side of the container wall 11 with respect to the fluid F. Keeping the transducers on the outside may be advantageous e.g. in maintenance and/or keeping the fluid out of contact. In other or further embodiments, the one or more acoustic transducers 21,22 may be partly, or completely buried in the container wall 11, to make it easier to couple the waves into the fluid. Preferably still, the one or more acoustic transducers 21,22 are not in contact with the fluid, e.g. to prevent contamination.

In some embodiments, a wedge element. 11w is arranged between the acoustic transducer 21,22 and the container wall 11 to determine the angle α. In another or further embodiment, the container wall 11 itself may contain or form a wedged surface against which the one or more acoustic transducers 21,22 can be mounted. The one or more acoustic transducers 21,22 may also be partly buried inside the container wall 11, e.g. at an angle with respect to the (inner) surface normal, or otherwise. While in the embodiment shown, the one or more acoustic transducers 21,22 are mounted at an angle onto the wedge element, alternatively, the transducers may be mounted in the same direction as the wall (in plane), e.g. by mounting a complementary second wedge element (not shown) onto the first wedge element. For example, the interconnected wedge elements may have different acoustic impedances for refracting the acoustic waves under the desired angle.

In some embodiments, one or more transducers are configured to predominantly direct acoustic waves in a direction of the fluid. In another or further embodiment, acoustic waves may also be directed along a wall of the container. For example, the transducer may be configured to induce guided waves in the wall of the container, which then refract into the liquid and create an acoustic (standing) wave field (in the liquid: compressional waves) This acoustic compressional wave field then induces liquid mixing. Also combinations can be envisaged, e.g. some transducers configured to generate waves directly into the fluid and other (or the same) transducers configured to generate guided waves in the container wall.

In some embodiments not shown), a direction of acoustic waves W1,W2 into the fluid (acoustic streaming direction) may be determined by a combination of individual waves produced by multiple acoustic transducers. For example, a phased array of transducers may be used, wherein an acoustic streaming or combined wave direction may be determined by the relative phases of the individual waves of the respective transducers forming the array. In one embodiment, the container wall 11 may be lined with an array of transducers and the streaming direction is switched, by adapting the relative phases at which the transducers are actuated.

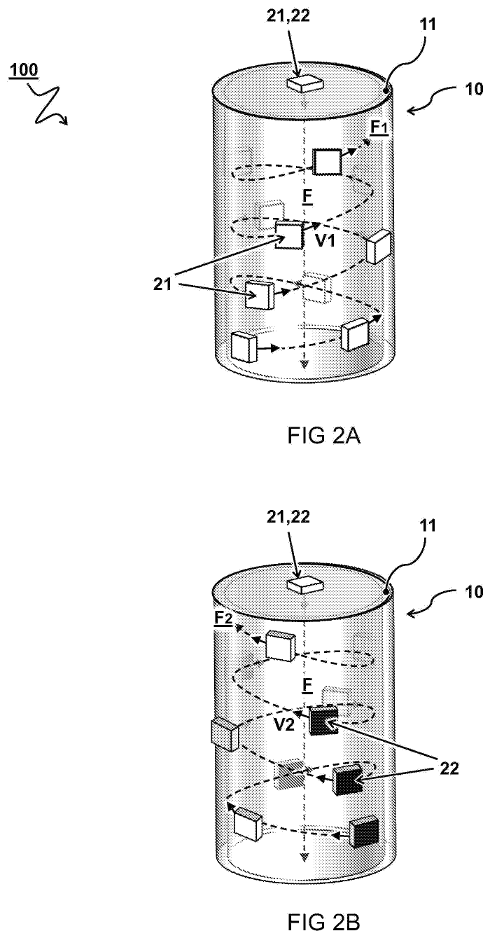

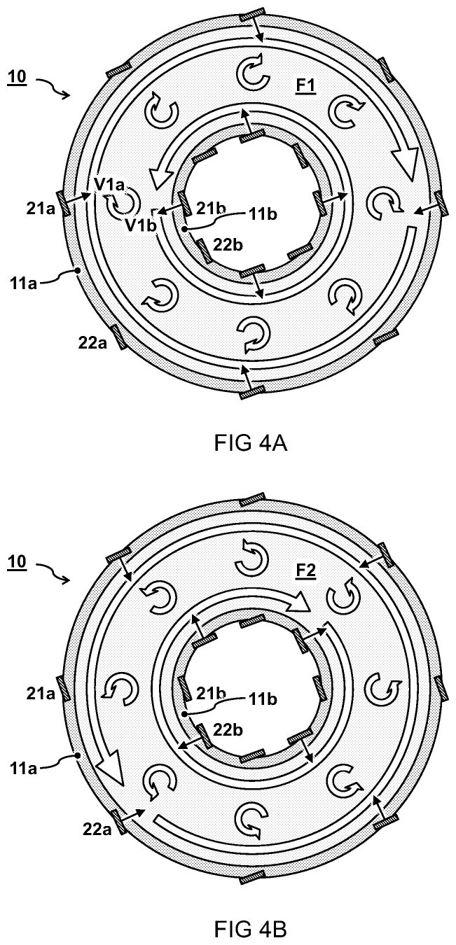

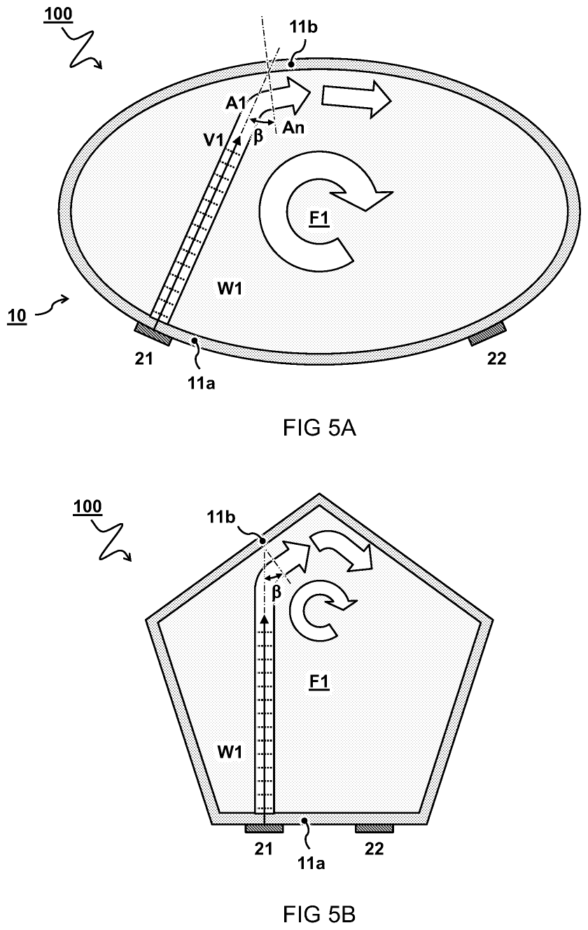

In some embodiments, the mixing container 10 has a circular shape and the transducers are arranged to cause a circular flow along the container wall 11. For example, the mixing container 10 may have a cylindrical shape, e.g. as shown in FIGS. 2A and 2B; or a toroidal shape, e.g. as shown in FIGS. 4A and 4B. Also elliptical shapes may be envisaged, e.g. as shown in FIG. 5A. Advantageously, using a circular (elliptical) shaped mixing container 10 may make it easier to develop a flow throughout while minimizing stagnant regions (where mixing is less). Alternatively, also other shaped mixing containers may be used, e.g. rectangular as shown in FIGS. 4A,4B; 6A,6B; or a polygonal shape, e.g. as shown in FIG. 5B. The corners in such shapes may help to develop local vortices which can also promote mixing.

FIGS. 2A and 2B illustrate embodiments wherein the one or more acoustic transducers 21,22 are configured to cause a helical flow pattern F1,F2 in the mixing container 10. For example, a helical flow pattern may comprise a general rotational flow component as well as a general longitudinal flow component transverse to the rotation. In some embodiments, e.g. as shown, the mixing container 10 has a cylindrical shape to guide the helical flow. For example, a set of first one or more acoustic transducers 21 is configured to cause a clockwise helical flow while a set of second one or more acoustic transducers 22 is configured to cause a counter-clockwise helical flow. Advantageously, the helical flow may be guided by the cylindrical container walls 11. In some embodiments, one or more transducers may be arranged to cause a fluid flow back through the middle of the container.

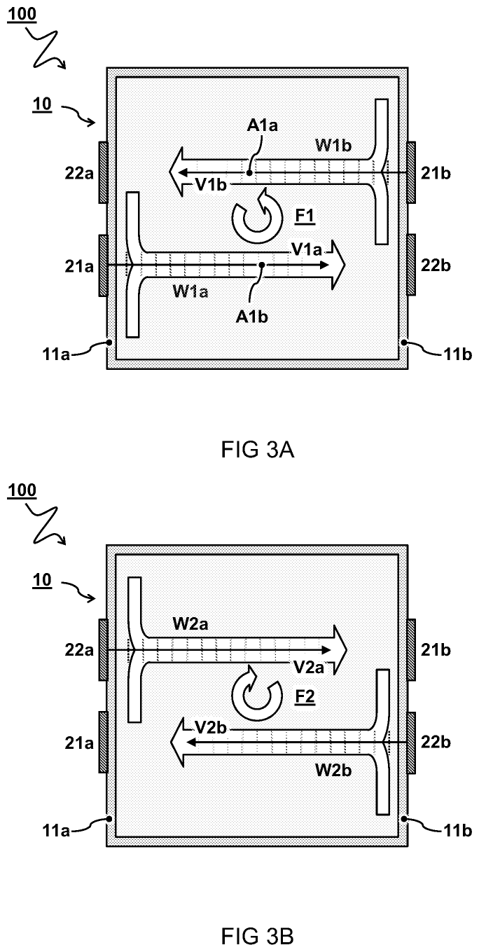

FIGS. 3A and 3B illustrate flow patterns with opposing flow directions. In some embodiments, e.g. as shown, a first transducer 21a is configured to direct its acoustic waves W1a along a first acoustic axis Ala in a first direction Via, while a second transducer 21b arranged on a second wall 11b of the container is configured to (simultaneously) direct its acoustic waves W1b along a second acoustic axis Alb in a second direction V1b. In one embodiment, the first direction Via is opposite to the second direction V1b. In another or further embodiment, the first acoustic axis Ala is offset with respect to the second acoustic axis Alb. Advantageously, a configuration of opposing non-paraxial or shearing flows may provide improved mixing, e.g. by vortex creation as illustrated. For example, this may improve mixing. Also paraxial opposing flow patterns may be envisaged which may cause a generally turbulent mixing between the transducers. In some embodiments, e.g. as shown, the first transducer 21a is arranged on a first wall Ha of the mixing container 10 and the second transducer 21b is arrange on an opposing, second wall of the mixing container 10.

In some embodiments, e.g. as shown or otherwise, one or more of the transducers 21,22 are configured to measure a respective flow pattern F1, F2. For example, some of the transducers may be used to measure a flow velocity and/or flow direction. For example, acoustic waves W1a may be generated by a first transducer 21a and measured by a second transducer 22h arranged in a path of the acoustic waves W1a, e.g. intersecting with the acoustic axis. In one embodiment, one or more transducers are configured to measure a flow velocity by Doppler shift. For example, continuous waves sent by a first transducer may be received by a second transducer, wherein the measured frequency by the second transducer is Doppler shifted with respect to the actuation of the first transducer depending on a direction and/or velocity of the flow there between. In another or further embodiment, one or more transducers are configured to measure a flow velocity by a time of arrival measurement. For example, a pulsed wave is sent by a first transducer may received by a second transducer, wherein the measured time between sending and receiving may depend on a direction and/or velocity of the flow there between (arriving faster with the flow than against the flow).

In some embodiments, the actuation of one or more of the transducers is controlled based on a flow measurement. For example, at least some to the actuators which are not used to generate the flow may be used to measure the flow. In one embodiment, a controller [not shown here] is configured to control the one or more acoustic transducers 21,22 to automatically switch between generation of different acoustic waves W1,W2 based on the measurement. For example, the flow may be switched when it is determined that a laminar flow has developed. Typically, in a laminar flow, the flow direction and/or velocity may be substantially non-changing. In another or further embodiment, the controller is configured to control the one or more acoustic transducers 21,22 to automatically adapt one or more of a frequency or intensity based on the measurement to keep a liquid velocity below a predetermined threshold. For example, this may prevent damage to some liquids caused by excessive shearing.

FIGS. 4A and 4B illustrate a toroidal or donut shaped mixing container 10. In some embodiments, e.g. as shown, a set of transducers 21a,21b is configured to cause opposing flows in the container, e.g. similar as explained with reference to the previous figures. In other or further embodiments (not shown), it can also be envisaged to cause a helical flow in a toroidal container. Advantageously, this allow a continuous helix around a channel formed by the container.

FIGS. 5A and 5B illustrate acoustic waves directed at an angle with respect to an opposing wall. In one embodiment, e.g. as shown, an acoustic transducer 21 is arranged on a first wall 11a of the mixing container 10 and configured to direct its acoustic waves W1 along an acoustic axis A1 (central or main direction) in a direction V1 impacting an opposing (inner) second wall 11b of the mixing container 10 at an impact angle β between the acoustic axis A1 and a normal An of the opposing second wall 11b, wherein the impact angle β is more than twenty degrees (plane angle), preferably more than thirty or even more than forty degrees, e.g. between forty-five degrees and seventy degrees. Advantageously, directing the flow direction V1 at an angle with respect to an opposing wall may cause the flow to bounce off the wall and/or be guided along the wall. For example, a circular flow may develop which mixes the fluid. In a preferred embodiment, e.g. as shown there may be a second transducer 22 configured to cause an opposite flow pattern (not shown).

In some embodiments, e.g. as shown in FIG. 5A, the mixing container 10 may be circular, or in this case cylindrical. Advantageously, the transducers may be placed off center (with respect to the centerlines of the ellipse) to impact an opposing wall at an angle. At the same time the circular inner wall may allow a circular flow to develop more easily. In other or further embodiments, e.g. as shown in FIG. 5B, the mixing container 10 may have a polygonal shape, e.g. square, pentagonal, hexagonal, et cetera. Also, in such configuration an acoustically induced stream may be directed by one or more acoustic transducers 21,22 to impact an opposing wall at an angle to cause flow patterns along the wall. Advantageously, vortices may develop particularly at corners of the polygonal shape.

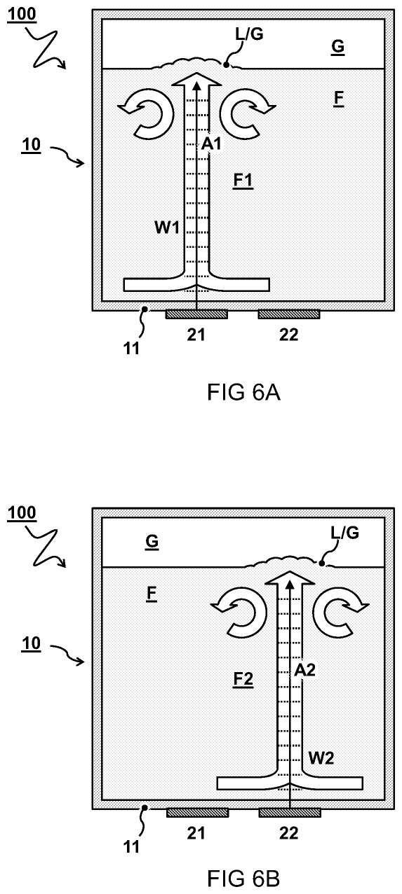

FIGS. 6A and 6B illustrate acoustic transducers 21,22 configured to direct their respective acoustic waves W1,W2 at a liquid/gas interface (L/G). Preferably, the waves impact the interface from a direction of the liquid, e.g. from below. Advantageously, the waves traversing an interface having different acoustic impedance may cause additional flow to develop by radiation force.

Without being bound by theory, the acoustic radiation force can be understood as a nonlinear phenomenon of ultrasound propagation. Typically, the acoustic radiation force enacts on objects or boundaries which have an acoustical impedance difference compared to the original medium in which the acoustic waves propagated. If the radiation force enacts on a free boundary, i.e. a liquid-air interface, in combination with a liquid jet (due to acoustic streaming) impinging on said free boundary, the liquid interface can start to vibrate, which can leads to an induced liquid flow. A radiation force enacted on a liquid-solid boundary (e.g. a stiff thick solid wall) typically will not lead to extra liquid flow. However, if compressible particles/gas bubbles are dispersed in the liquid medium (thus causing acoustic impedance differences at the locations of the particles/gas bubbles) the particles/gas bubbles can start to move due to the radiation force. The particles/gas bubbles move the liquid aside in turn, thus causing liquid movement. This is next to the liquid movement caused by the absorption of sound in said liquid (acoustic streaming).

In some embodiments (not shown), the respective acoustic axis is directed at an angle, e.g. of more than thirty degrees, with respect to the normal of the interface to cause a flow along the interface surface, similar as explained in the previous figure. For example, in the embodiment shown, a wedge element may be arranged between the one or more acoustic transducers 21,22 and the container wall 11 to direct the waves; or the bottom walls may be sloped.

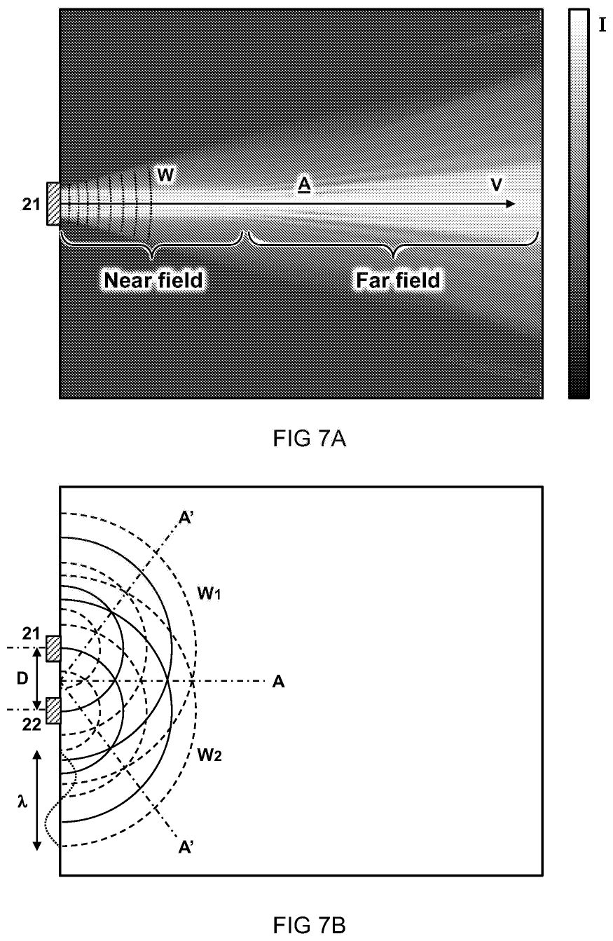

FIG. 7A illustrates a pressure distribution intensity “I” corresponding to one transducer 21. As shown, the acoustic waves “W” nay be predominantly directed along one acoustic axis “A” to induce a corresponding flow direction “V”. Typically, the acoustic wave field is more directional when the wavelength of the acoustic waves is small compared to one or more dimensions of the transducer on the wall. In the case of a wave field produced by a transducer with a large opening angle (for example as produced if the wavelength is large compared to one or more dimensions of the transducer) guided waves may be produced in the container wall. In some embodiments, a frequency of the transducer may be switched between a first mode wherein the wavelength of the acoustic waves (e.g. in the container wall and/or fluid) is larger than an extent, e.g. diameter along the wall, of the transducer; and a second mode wherein the wavelength is smaller than the extent of the transducer. Accordingly, this may induce distinct wave patterns/directions. Of course also other frequency variations can be envisaged to switch between different modes. In one embodiment, a frequency sweep is applied, e.g. low frequency produces different acoustic field for unfocused transducer than high frequency. There could also be combination of low and high frequency components.

FIG. 7B illustrates interference between acoustic waves of different, e.g. adjacent, transducers 21,22. As shown, the interference of different waves may lead to constructive and/or destructive interference. In some embodiments, a distance between adjacent transducers 21,22 may be less than a wavelength A of the acoustic waves (e.g. in the fluid). In some embodiments, constructive interference between acoustic waves of different transducers 21,22 may cause one or more secondary beams (grating lobes) along secondary axes A′ where the pressure variation or acoustic streaming is relatively high.

Without being bound by theory it is observed that the direction of the secondary axes is dependent on the wavelength, e.g. constructive interference takes place at locations in the fluid where the distance relative to the different transducers is an integer number times the wavelength. This may be similar to an (optical) grating. It will be appreciated that the direction of the secondary axes can be controlled e.g. by controlling the frequency of the transducers. In some embodiments, a frequency of the transducers may be switched between a first mode wherein the wavelength of the acoustic waves (e.g. in the container wall and/or fluid) is larger than a (center) distance D between the transducers, e.g. along the wall; and a second mode wherein the wavelength is smaller than the distance. It can also be envisaged to switch between three different frequencies. For example, in a first mode with a relatively low frequency there may be no grating lobes; at higher frequencies grating lobes may come into being; at even higher frequencies the grating lobes move towards the main beam.

Also, other variations can be envisaged in combination or separate from frequency variation. In one embodiment, an amplitude modulation of a wave field may be produced by a single transducer, or multiple transducers. In another or further embodiment, lengths of sine wave bursts over time produced by one or more transducers can be varied. In some embodiments, a shape or size of different transducers may be different between different modes. In one embodiment, a first transducer actuated in a first mode has a first diameter, and a second transducer actuated in a second mode has a second diameter which may be smaller or larger than the first diameter. In another or further embodiment, the transducers comprise an annular array, e.g. comprising (concentric rings) with different sizes or diameters. The transducers of different sizes may be actuated at the same or different frequencies. For example, switching between transducers may cause a change in sound field shape, e.g. because the source aperture changes. Also, the efficiency with which acoustic streaming is induced may changes (e.g. by square of the diameter dependency, as will be discussed in the formula below). When the frequencies are different this may provide an even further effect (frequency dependency also discussed below). The combination of high and low frequency components could also be used to optimize the induced fluid velocity field. Of course the different options can be combined.

Acoustic streaming of a liquid is induced by the absorption of acoustic waves during the propagation of these waves through said liquid. Thus, acoustic streaming may occur in all acoustic radiation fields, depending on the shape of the field and the properties of the medium (liquid/gas). Without being bound by theory, acoustic streaming may generally be related to sound attenuation in the fluid. The inventors find that an induced liquid velocity by acoustic streaming can be approximated by the following proportionality relation:

$$V ∝ \frac{{p}^{2} \cdot {a}^{2} \cdot {d}_{c} \cdot {f}^{π}}{{c}_{0} \cdot {μ}_{0}}$$

where “V” is the induced (peak) liquid velocity; “p” is the acoustic pressure in the fluid (e.g. p² may be proportional to the sound intensity I₀ at the transducer surface); “a” is the radius (or diameter) of the transducer; “c₀” is an the acoustic wave velocity in the fluid; “μ₀” is the viscosity of the fluid; “d_{c}” is a duty cycle of the transducer; “f” is the frequency of the acoustic waves; “n” is a number between one and two.

In some embodiments, an acoustic pressure or sound intensity at the transducer surface may be controlled to provide a desired liquid velocity. In other or further embodiments, it may be desired to prevent damage to the liquid, e.g. milk, by keeping a relatively low peak pressure in the liquid, e.g. less than one mega Pascal, preferably less than five hundred kilo Pascal, more preferably less than three hundred kilo Pascal, e.g. between one kilo Pascal and two hundred kilo Pascal. This may also depend, e.g., on the frequency.

In some embodiments, a frequency of the transducers is controlled to provide a desired liquid velocity. For example, a frequency for mixing liquids is selected in a ranged between 0.1-100 MHz, preferably between 0.5-5 MHz, more preferably between 0.8-3 MHz. In some embodiments, the transducers are configured to operate in a resonant mode to increase power efficiency.

In some embodiments, one or more, preferably all the acoustic transducers may be relatively large, e.g. more than one centimeter in diameter, more than two centimeters, more than five centimeters, or even more than ten centimeters (along the container wall). As indicated in the above relation, increasing a size of the transducer may be more efficient in achieving a desired liquid velocity.

In some embodiments, it is desired to keep a relatively low peak liquid velocity, e.g. less than one meter per second, less than half a meter per second, less than 0.3 m/s, or even, less. For example, in some liquids such as milk it may be desired to keep a relatively low peak liquid velocity, e.g. between 0.01-0.3 m/s, preferably less than 0.2 m/s, to prevent damage by shearing.

To prevent high peak velocities, while still providing sufficient mixing, e.g. a relatively high number of low power transducers may be used. In some embodiments, at least one transducer may be used for every two-hundred liters being mixed, for every hundred liters being mixed, for every fifty liters being mixed, for every ten liters being mixed or even more than one transducer per liter of liquid in the mixing container. In other or further embodiments, each transducer may be powered at less than hundred Watts, less than fifty Watts, less than twenty Watts, or even less than ten Watts, e.g. between one and five Watts each. For example, mixing in a 4000 liter tank of milk may use forty transducers with total power of about 100 W.

In preferred applications, e.g. keeping a storage container with fluid in a mixed condition, the mixing container has a relatively large volume. For example, the container is configured to hold a volume of fluid of more than one liter, more than ten liters, more than hundred liters, or even more than a thousand liters (one cubic meter), e.g. between four thousand liter and ten thousand liters, or more. For example, the present system may be applied in a container used for storage and/or or transporting of milk, e.g. in a container on the back of a truck. To mix a relatively large volume of fluid, or keep the fluid mixed, an arrangement of many acoustic transducers may be used. For example, more than ten acoustic transducers may be used, more than fifty, or even more than hundred.

The power needed to mix the fluid (or keep it mixed) may vary depending on the configuration of the transducers, the shape of the mixing container, and the type of fluid. For example, by optimizations described herein the power needed for mixing a four thousand liter tank of milk is found to be approximately between hundred watt and one kilowatt. Depending on the efficiency, a large portion of this power may be dissipated as heat in the fluid being mixed. For example, 1 kW of power being dissipated in 4000 kg of liquid with heat capacity of 4 kJ/kg K would cause negligible temperature increase in about five minutes ((1 kW/4000 kg) (4 kJ/kg K)=0.000062 K/s).

In some embodiments, it is preferred to keep the energy being dissipated in the fluid while mixing relatively low. In a preferred embodiment, the configuration is adapted to dissipated less ten Watt per liter, less than one Watt per liter, less then half a Watt per liter, or even less than one tenth of a Watt per liter (0.1 W/1). In other or further embodiments, measures may be taken to prevent heating of the fluid by acoustic mixing. In one embodiment, the apparatus 100 comprises an active cooler to at least partially, or even fully, counteract heating of the fluid caused by the acoustic transducers. For example, the active cooler has a cooling capacity which is at least equal to the heat dissipation of the acoustic waves in the fluid. For example, the active cooler may be controlled based on a temperature measurement of the fluid. In some embodiments, the cooling may be switched based actuation of the acoustic transducers. In one embodiment, one or more acoustic transducers are configured to specifically cause a fluid flow along an actively cooled surface.

It will be appreciated that the present teachings of contactless mixing are particularly suitable for applications where it is important to prevent contamination while mixing fluids (or keeping them mixed), such as in the food industry, medicine, or general chemical industry. In some embodiments, the fluid being mixed has a relatively high viscosity (compared to water), e.g. more than two Centipoise (=milli-Pascal Second). For example, milk has a typical viscosity of three Centipoise (at room temperature. In one embodiment, the fluid being mixed is milk wherein the configuration is controlled to keep a peak liquid velocity below thirty centimeters per second, and a peak acoustic pressure kept below one mega Pascal.

For the purpose of clarity and a concise description, features are described herein as part of the same or separate embodiments, however, it will be appreciated that the scope of the invention may include embodiments having combinations of all or some of the features described. For example, while embodiments were shown for switching different flow patterns, also alternative ways may be envisaged by those skilled in the art having the benefit, of the present disclosure for achieving a similar function and result. E.g. different configurations may be combined or split up into one or more alternative components. The various elements of the embodiments as discussed and shown offer certain advantages, such as mixing easily damaged fluids. Of course, it is to be appreciated that any one of the above embodiments or processes may be combined with one or more other embodiments or processes to provide even further improvements in finding and matching designs and advantages. It is appreciated that this disclosure offers particular advantages to the food industry; and in general can be applied for any application wherein a fluid, e.g. liquid or gas, is to be mixed or to be kept mixed.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include working combinations of the claims wherein each claim can in principle refer to any preceding claim unless clearly excluded by context.

1. An apparatus for mixing a fluid, the apparatus comprising:
a mixing container comprising a container wall for holding the fluid at least one acoustic transducer arranged on the container wall and configured to selectively generate a respective set of acoustic waves, wherein each respective set of acoustic waves is directed along a respective specific acoustic axis corresponding to a central or main direction of the set of acoustic waves into the fluid for causing a respective flow pattern in the fluid by acoustic streaming along the specific acoustic axis, wherein the acoustic axis of each respective set of acoustic waves is at a respective angle of more than thirty degrees with respect to a normal of the container wall; and
a controller configured to control the at least one acoustic transducer to automatically switch between selective generation of different sets of acoustic waves for causing switching between different ones of the respective flow patterns.

2. The apparatus of claim 1, wherein one or more of the at least one acoustic transducer are configured to switch to operate during a first period of time and a second period of time to cause:
a first flow pattern by generating a first set of acoustic waves over the first period of time, and
a second flow pattern, different from the first flow pattern, by generating a second set of acoustic waves, different from the first set of acoustic waves, over the second period of time.

3. The apparatus of claim 2, wherein a first subset of at least one transducer is configured to cause the first flow pattern, and
wherein a different, second subset of at least one other transducer is configured to cause the second flow pattern.

4. The apparatus of claim 2, wherein
the respective angles of the acoustic waves are oppositely directed along a circumference of the container wall between the different flow patterns, for causing the first flow pattern to have a first flow direction tangential to the container wall at a position in the mixing container and a second flow pattern to have an opposing, second flow direction tangential to the container wall at a same position in the mixing container.

5. The apparatus of claim 1, wherein the respective angle is determined by at least one of the group consisting of:
a wedge element arranged between a one of the at least one acoustic transducer and the container wall;
the container wall containing or forming a wedged surface against which the at least one acoustic transducer is mounted; and
the at least one acoustic transducer being at least partly buried inside the container wall at an angle with respect to an inner surface normal of the container wall.

6. The apparatus of claim 1, wherein the mixing container has a circular shape, and wherein ones of the at least one acoustic transducer are arranged to cause a circular flow along the container wall.

7. The apparatus of claim 1, wherein the mixing container has a cylindrical or toroidal shape, and
wherein one or more acoustic transducers of the at least one transducer to cause a helical flow pattern in the mixing container.

8. The apparatus of claim 1, wherein a first transducer of the at least one acoustic transducer is configured to direct its acoustic waves along a first acoustic axis in a first direction,
wherein a second transducer of the at least one acoustic transducer, arranged on a second wall of the container, is configured to direct its acoustic waves along a second acoustic axis in a second direction,
wherein the first direction is opposite to the second direction; and
wherein the first acoustic axis is offset with respect to the second acoustic axis.

9. The apparatus of claim 1, wherein an acoustic transducer of the at least one acoustic transducer is arranged on a first wall of the mixing container and configured to direct its acoustic waves along an acoustic axis in a direction impacting an opposing second wall of the mixing container at an impact angle between the acoustic axis and a normal of the opposing second wall, and wherein the impact angle is more than thirty degrees.

10. The apparatus of claim 1, wherein one or more acoustic transducers of the at least one acoustic transducer are configured to direct their respective acoustic waves at a liquid/gas interface.

11. The apparatus of claim 1, wherein one or more acoustic transducers, of the at least one acoustic transducer, are configured to measure a respective flow pattern.

12. The apparatus of claim 11, wherein the controller is configured to control one or more acoustic transducers, of the at least one acoustic transducer, to switch, in accordance with measurements of the respective flow pattern, between generating different acoustic waves based on the measurement.

13. The apparatus of claim 11, wherein the controller is configured to control one or more acoustic transducers, of the at least one acoustic transducer, to automatically adapt, based on the measurement to keep a liquid velocity below a predetermined threshold, one or more parameters taken from the group consisting of:
a frequency, and
intensity.

14. A method for mixing a fluid comprising
holding the fluid in a mixing container;
selectively generating a respective set of acoustic waves, wherein each respective set of acoustic waves is directed along a specific acoustic axis corresponding to a central or main direction of the set of acoustic waves into the fluid for causing a respective flow pattern in the fluid by acoustic streaming along the specific acoustic axis, wherein the acoustic axis of each respective set of acoustic waves is at a respective angle of more than thirty degrees with respect to a normal of the container wall; and
automatically switching between selective generation of different sets of acoustic waves for causing switching between different ones of the respective flow patterns.

15. The method of claim 14, wherein the fluid is milk and a peak liquid velocity is kept below thirty centimeters per second, and a peak acoustic pressure is kept below one mega Pascal.

16. The method of claim 14, wherein one or more acoustic transducers automatically switch to operate during a first period of time and a second period of time to cause:
a first flow pattern by generating a first set of acoustic waves over the first period of time; and
a second flow pattern, different from the first flow pattern, by generating a second set of acoustic waves, different from the first set of acoustic waves, over the second period of time.

17. The method of claim 16, wherein a first subset of at least one transducer causes the first flow pattern, and a different, second subset of at least one other transducer causes the second flow pattern.

18. The method of claim 16, wherein respective angles of the acoustic waves are oppositely directed along a circumference of the container wall between the different flow patterns, causing:
the first flow pattern to have a first flow direction tangential to the container wall at a position in the mixing container, and
a second flow pattern to have an opposing, second flow direction tangential to the container wall at the same position in the mixing container.

19. The method of claim 14, wherein the respective angle is determined by at least one of the group consisting of:
a wedge element arranged between the acoustic transducer and the container wall;
the container wall containing or forming a wedged surface against which the at least one acoustic transducer is mounted; and
the at least one acoustic transducer being at least partly buried inside the container wall at an angle with respect to an inner surface normal of the container wall.

20. The method of claim 14, wherein the mixing container has a circular or toroidal shape, and
wherein one or more acoustic transducers of the at least one acoustic transducer cause a circular flow pattern or a helical flow pattern along the container wall in the mixing container.
